(19) United States
(12) Patent Application Publication
(10) Pub. No.: US 2026/0079419 A1
(43) Pub. Date: Mar. 19, 2026

(54) IMAGE FORMING APPARATUS

(71) Applicant: CANON KABUSHIKI KAISHA, Tokyo (JP)

(72) Inventors: NORITOMO YAMAGUCHI, Kanagawa (JP); TAKEO KAWANAMI, Kanagawa (JP); AKINORI MITSUMATA, Tokyo (JP)

(21) Appl. No.: 19/313,600

(22) Filed: Aug. 28, 2025

(30) Foreign Application Priority Data
Sep. 13, 2024 (JP) 2024-158772

(51) Int. Cl. G03G 15/01; G03G 15/08; G03G 21/16

(52) U.S. Cl. CPC G03G 15/0121; G03G 15/0189; G03G 15/0808; G03G 15/0875; G03G 15/0896; G03G 21/1619; G03G 2221/1684

(57) ABSTRACT

An image forming apparatus includes a first developing unit that is disposed above a first toner container and a second toner container, a second developing unit that is aligned with the first developing unit in a second direction intersecting a first direction and the direction of gravity and is disposed above the first toner container and the second toner container, a first path through which first toner passes, and a second path through which second toner passes, and is characterized in that the first developer container is replenished with the first toner from the first toner container through the first path, and the second developer container is replenished with the second toner from the second toner container through the second path.

### BACKGROUND

### Field of the Technology

The present disclosure relates to an image forming apparatus and a toner container for use in the same.

### Description of the Related Art

In electrophotographic type image forming apparatuses, a configuration in which a developer container in the image forming apparatus is replenished with toner by using a toner container that is detachably attachable to the image forming apparatus is known. Japanese Patent Laid-Open No. 2020-154300 describes a configuration in which a replenishment pack is attached to an image forming apparatus so that toner can be easily replenished without replacing a developer container.

### SUMMARY

According to an aspect of the present disclosure, an image forming apparatus includes a first toner container configured to store first toner, a second toner container configured to store second toner, the second toner container being aligned with the first toner container in a first direction intersecting a direction of gravity, and an apparatus main body configured in such a manner that the first toner container and the second toner container are detachably attachable to the apparatus main body, wherein the apparatus main body includes a first developing unit that includes a first developing roller configured to be rotatable to carry the first toner and a first developer container for storing the first toner to be carried by the first developing roller, and is disposed above the first toner container and the second toner container, a second developing unit that includes a second developing roller configured to be rotatable to carry the second toner and a second developer container for storing the second toner to be carried by the second developing roller, is aligned with the first developing unit in a second direction intersecting both the first direction and the direction of gravity, and is disposed above the second toner container, and a first path through which the first toner passes, and wherein the first developer container is replenished with the first toner from the first toner container through the first path, when viewed in the direction of gravity, both the direction in which the first toner container is detachably mounted, and the direction in which the sheet is discharged onto the discharge tray, are the second direction.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a cross-sectional view of an image forming apparatus according to a first embodiment.

FIG. 2 is a diagram illustrating a perspective view of the image forming apparatus according to the first embodiment.

FIG. 3 is a diagram illustrating a perspective view of a toner container and an image forming unit of the image forming apparatus according to the first embodiment.

FIGS. 4A and 4B are diagrams illustrating a connection section of a toner replenishing unit with the toner container according to the first embodiment.

FIGS. 5A to 5C are diagrams illustrating cross-sectional views of the toner container according to the first embodiment in attached and detached states.

FIG. 6 is a diagram illustrating a top view illustrating an arrangement of a process cartridge and a toner cartridge according to the first embodiment.

FIGS. 7A and 7B are diagrams illustrating a link operation by opening and closing operations of a front door according to the first embodiment.

FIG. 8 is a diagram illustrating a perspective view of an image forming apparatus according to a second embodiment.

FIG. 9 is a diagram illustrating a cross-sectional view of a toner replenishing unit according to the second embodiment.

### DESCRIPTION OF THE EMBODIMENTS

### First Embodiment

### (Image Forming Apparatus)

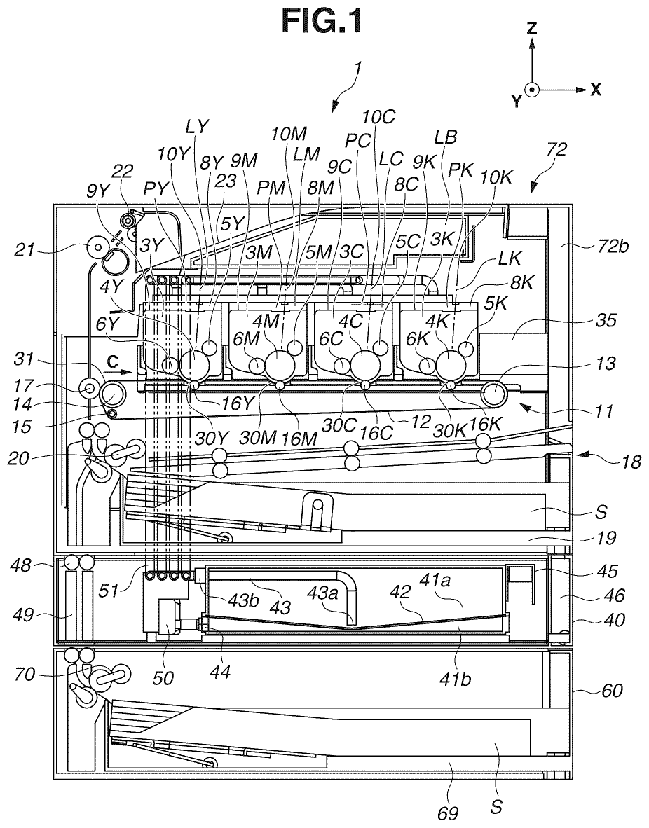

An image forming apparatus 1 according to a first embodiment of the present disclosure is described with reference to FIG. 1. The image forming apparatus 1 of an electrophotographic type according to the present embodiment is a full-color image forming apparatus equipped with four color process units. FIG. 1 is a diagram illustrating a main cross section of the image forming apparatus 1.

The image forming apparatus 1 is a full-color laser printer using an electrophotographic process and can form a full-color image on a recording medium S. The image forming apparatus 1 includes process units PY, PM, PC, and PK (hereinbelow, each may be referred to as process unit P) and an apparatus main body 72. The process units P are aligned with a first direction X (first direction) and each contain toner of color different from each other. A longitudinal direction of the process units P aligns with a second direction Y (second direction) perpendicular to the first direction. The process units PY, PM, PC, and PK are referred to as first, second, third, and fourth process units, respectively. Suffixes Y, M, C, and K attached to reference symbols indicate toner color. Yellow, magenta, cyan, and black are represented by Y, M, C, and K, respectively. Hereinbelow, the same applies to units other than the process unit P.

Each process unit P includes an electrophotographic process element. To the process unit P, a rotation driving force is transmitted from a drive output unit (not illustrated) of the apparatus main body 72, and a bias voltage (a charging bias, a developing bias, or the like) is supplied from a bias application unit (not illustrated) of the apparatus main body 72.

As illustrated in FIG. 1, the process units P are respectively provided with drum units 8Y, 8M, 8C, and 8K (hereinbelow, each may be referred to as drum unit 8). The drum units 8 include photosensitive drums 4Y, 4M, 4C, and 4K (hereinbelow, each may be referred to as photosensitive drum 4), respectively, and charging rollers 5Y, 5M, 5C, and 5K (hereinbelow, each may be referred to as charging roller 5) as process units that act on the respective photosensitive drums 4. Each of the photosensitive drum 4 is rotatably arranged so that a direction of its rotation axis is along the second direction Y. The photosensitive drums 4Y, 4M, 4C, and 4K are referred to as first, second, third, and fourth photosensitive drums, respectively.

The process units P are provided with developing units 9Y, 9M, 9C, and 9K (hereinbelow, each may be referred to as a developing unit 9), respectively, that include developing rollers 6Y, 6M, 6C, and 6K (hereinbelow, each may be referred to as developing roller 6), respectively, for developing electrostatic latent images on the corresponding photosensitive drums 4. The developing units 9 are aligned with the first direction X. The developing rollers 6Y, 6M, 6C, and 6K, which are rotatably configured, are referred to as first, second, third, and fourth developing rollers, respectively. The developing units 9Y, 9M, 9C, and 9K are referred to as first, second, third, and fourth developing units, respectively.

The developing unit 9Y includes a developer container 3Y (first developer container) storing yellow (Y) toner (first toner) and is configured in such a manner that the yellow (Y) toner is supplied to a surface of the photosensitive drum 4Y by the developing roller 6Y for carrying the yellow (Y) toner.

The developing unit 9M includes a developer container 3M (second developer container) storing magenta (M) toner (second toner) and is configured in such a manner that the magenta (M) toner is supplied to a surface of the photosensitive drum 4M by the developing roller 6M for carrying the magenta (M) toner.

The developing unit 9C includes a developer container 3C (third developer container) storing cyan (C) toner (third toner) and is configured in such a manner that the cyan (C) toner is supplied to a surface of the photosensitive drum 4C by the developing roller 6C for carrying the cyan (C) toner.

The developing unit 9K includes a developer container 3K (fourth developer container) storing black (K) toner (fourth toner) and is configured in such a manner that the black (K) toner is supplied to a surface of the photosensitive drum 4K by the developing roller 6K for carrying the black (K) toner.

In a third direction Z intersecting both the first direction X and the second direction Y, a laser scanner unit LB (an exposure unit) is disposed above the process units P (photosensitive drums 4). The laser scanner unit LB outputs a laser beam corresponding to image information.

The third direction Z according to the present embodiment is along a direction of gravity.

Hereinbelow, optical paths of laser beams toward the photosensitive drums 4Y, 4M, 4C, and 4K are referred to as optical paths LY, LM, LC, and LK (hereinbelow, each may be referred to as optical path L or optical paths L), respectively. The laser beams pass through exposure windows 10Y, 10M, 10C, and 10K of the laser scanner unit LB to scan and expose surfaces of the respective photosensitive drums 4. A light-emitting diode (LED) exposure unit may be used instead of the laser scanner unit LB.

In the third direction Z, an intermediate transfer belt unit 11 serving as a transfer member is disposed below the process units P. The intermediate transfer belt unit 11 includes a drive roller 14, a tension roller 13, and an assist roller 15, and a flexible transfer belt 12 is stretched around these rollers.

A lower surface of each of the photosensitive drums 4 is in contact with an upper surface of the transfer belt 12. The photosensitive drums 4 and the transfer belt 12 form primary transfer portions 30Y, 30M, 30C, and 30K (hereinbelow, referred to as primary transfer portions 30), respectively. Primary transfer rollers 16Y, 16M, 16C, and 16K (hereinbelow, each may be referred to as transfer rollers 16) are disposed to face the respective photosensitive drums 4 on an inner surface of the transfer belt 12.

The drive roller 14 is pressed against a secondary transfer roller 17 via the transfer belt 12. A secondary transfer part 31 is formed on a contact part between the transfer belt 12 and the secondary transfer roller 17.

A feeding unit 18 is disposed below the intermediate transfer belt unit 11 in the third direction Z. The feeding unit 18 includes a sheet feeding tray 19 for stacking and storing the recording medium S thereon and a sheet feeding roller 20 for picking up the recording medium S from the sheet feeding tray 19 and conveys the recording medium S.

A fixing unit 21 for fixing a toner image to the recording medium S and a discharging roller 22 for discharging the recording medium S to which the toner image has been fixed to a discharge tray 23 are disposed on an upper part of the apparatus main body 72 in FIG. 1. The discharging roller 22 discharges the recording medium S in a direction along the first direction X.

In the present embodiment, a downstream side in a discharge direction, in which the recording medium S is discharged toward the discharge tray 23 by the discharging roller 22, is defined as a front side of the image forming apparatus 1, and an upstream side in the discharge direction is defined as a rear side of the image forming apparatus 1.

In the third direction Z, a toner replenishing unit (toner container support portion) 40 is disposed below the feeding unit 18. The toner replenishing unit 40 can replenish the developer containers 3 with toner T stored in toner cartridges 41 via a toner conveyance path 51.

Next, a configuration of the toner cartridges 41 is described. In each of the toner cartridge 41, a toner chamber (toner storage chamber) 41a storing the toner T therein and an air chamber 41b connected to the outside are partitioned by a filter 42. The filter 42 allows air to pass through but prevents and restricts the toner T from passing through. The toner chamber 41a has a toner path 43 that connects a toner suction port 43a and a toner discharge port 43b. An outer periphery of the filter 42 is fixed to a frame.

Next, conveyance of the toner T is described. Air is supplied to an air supply port 44 of the toner cartridge 41 by a pump unit 50 disposed in the toner replenishing unit 40. The supplied air passes through the filter 42 and is supplied to the toner chamber 41a. The air supplied from the air supply port 44 mixes with the toner T and fluidizes the toner T. The fluidized toner T flows into the toner path 43 from the toner suction port 43a. The toner T passes through the toner conveyance path 51 and is supplied to the corresponding developer container of the developer containers 3.

A shaftless screw that rotates by receiving a driving force from an actuator may be used without using the pump unit 50.

The toner replenishing unit 40 includes a front cover 46 that is openable and closable, and closes an opening for accessing the toner cartridge 41. After opening the front cover 46, a user can insert his/her hand through the opening and pull out the toner cartridge 41 by holding a handle 45 provided on the front side of the toner cartridge 41.

In the third direction Z, an optional feeding unit 60 is disposed below the toner replenishing unit 40. The optional feeding unit 60 is provided with a sheet feeding tray 69 on which the recording medium S is stacked and stored, and a sheet feeding roller 70 that picks up the recording medium S from the sheet feeding tray 69 and conveys the recording medium S.

The toner replenishing unit 40 is provided with a conveyance roller 48 and a conveyance guide 49 that convey the recording medium S picked up in the optional feeding unit 60 to the main body 72 of the image forming apparatus 1.

### (Image Forming Operation)

An image forming operation for forming a full-color image is as follows. Each of the photosensitive drums 4 is rotatively driven counterclockwise in FIG. 1 at a predetermined speed. The transfer belt 12 is rotatively driven in a forward direction (a direction of an arrow C in FIG. 1) of the rotation of the photosensitive drums 4 at a speed corresponding to a rotation speed of the photosensitive drums 4.

In synchronization with an operation of the laser scanner unit LB, each of the charging rollers 5 uniformly charges the surface of the corresponding photosensitive drum of the photosensitive drums 4 to a predetermined polarity and potential in each of the process units P. The laser scanner unit LB scans and exposes the charged surface of each of the photosensitive drums 4 with a laser beam according to an image signal of each color. On the surface of each of the photosensitive drums 4, an electrostatic latent image corresponding to the image signal of each color is formed.

The laser scanner unit LB exposes the photosensitive drum 4Y with the laser beam via the laser beam path LY, so that a first electrostatic latent image is formed on the photosensitive drum 4Y.

Similarly, the photosensitive drums 4M, 4C, and 4K are exposed with laser beams via the laser beam paths LM, LC, and LK, respectively, emitted from the laser scanner unit LB. Then, second, third, and fourth electrostatic latent images are formed on the photosensitive drums 4M, 4C, and 4K, respectively.

Toner is supplied to each of the photosensitive drums 4 by the corresponding developing roller of the developing rollers 6 that are rotated clockwise in FIG. 1 at a predetermined speed, so that the electrostatic latent images on the respective photosensitive drums 4 are developed.

A yellow toner image is formed on the photosensitive drum 4Y of the process unit PY by the electrophotographic image forming process described above. Then, the yellow toner image is primarily transferred to the transfer belt 12.

A magenta toner image is formed on the photosensitive drum 4M of the process unit PM by a similar process. Then, the magenta toner image is primarily transferred to the transfer belt 12 so that the magenta toner image is superimposed on the yellow toner image on the transfer belt 12.

A cyan toner image is formed on the photosensitive drum 4C of the process unit PC. Then, the cyan toner image is primarily transferred to the transfer belt 12 so that the cyan toner image is superimposed on the yellow and magenta toner images on the transfer belt 12.

A black toner image is formed on the photosensitive drum 4K of the process unit PK. Then, the black toner image is primarily transferred to the transfer belt 12 so that the black toner image is superimposed on the yellow, magenta, and cyan toner images on the transfer belt 12.

In the way above described, unfixed full-color toner images of four colors, yellow, magenta, cyan, and black are formed on the transfer belt 12. Meanwhile, the recording medium S is separated and fed one by one from the sheet feeding tray 19 by the sheet feeding roller 20 at a predetermined control timing. The recording medium S is conveyed at the predetermined control timing to the secondary transfer part 31, which is a contact part between the secondary transfer roller 17 and the transfer belt 12. In the process in which the recording medium S is conveyed through the secondary transfer part 31, the four-color superimposed toner images on the transfer belt 12 are transferred to the recording medium S. The recording medium S on which the toner images has been transferred is heated and pressed by the fixing unit 21, so that the toner images are fixed to the recording medium S. The recording medium S on which the toner images has been fixed is discharged to the discharge tray 23 by the discharging roller 22.

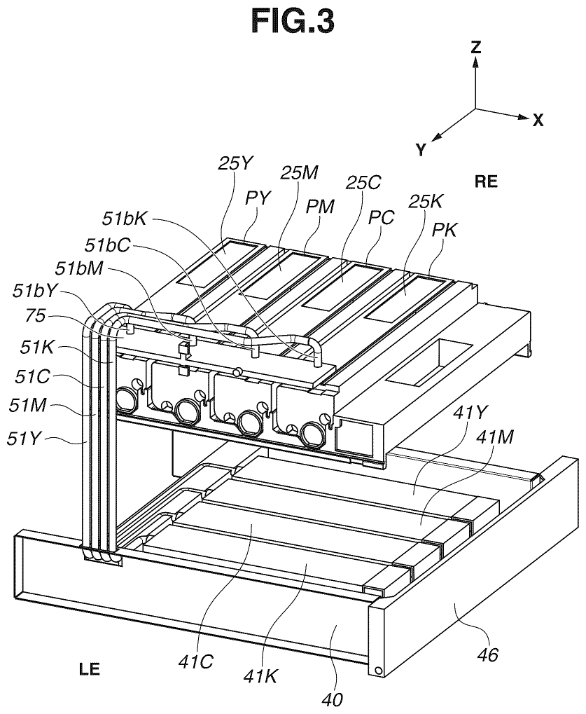

As illustrated in FIG. 3, the image forming apparatus 1 includes toner cartridges 41Y, 41M, 41C, and 41K (hereinbelow, each may be referred to as toner cartridge 41) that are detachably attachable to the toner replenishing unit 40. Each of the toner cartridges 41 is aligned with the second direction Y. In other words, each of the toner cartridges 41 is aligned with a direction intersecting the first direction X with which each of the developing units 9 is aligned. According to the present embodiment, the first direction X and the second direction Y are perpendicular to each other. The toner cartridges 41Y, 41M, 41C, and 41K are referred to as a first cartridge (first toner container), a second cartridge (second toner container), a third cartridge (third toner container), and a fourth cartridge (fourth toner container), respectively.

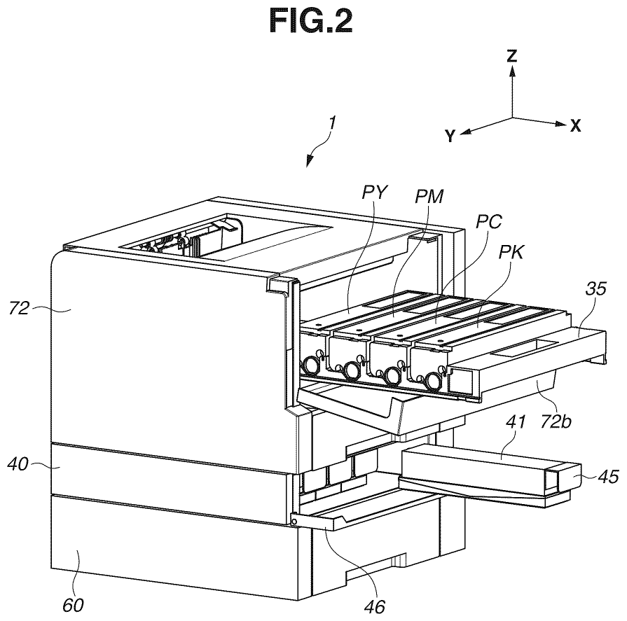

FIG. 2 is a diagram illustrating a perspective view of the image forming apparatus 1 in a state in which a front door 72b of the apparatus main body 72 and the front cover 46 of the toner replenishing unit 40 are open.

The front door 72b is configured to be movable between a closed position (see FIG. 1) in which the opening of the apparatus main body 72 on the front side is closed and an open position (see FIG. 2) in which the opening is open.

The process units P are held by a process unit tray 35 as illustrated in FIG. 2. The process unit tray 35 is configured to be movable between the inside and outside of the apparatus main body 72.

FIG. 2 illustrates a state in which the process unit tray 35 is pulled out from the apparatus main body 72. In the state in which the process unit tray 35 is pulled out from the apparatus main body 72, a user can replace the process units P.

Each of the toner cartridges 41 is configured to be attached to the front side of the toner replenishing unit 40 so that the user can access the toner cartridges 41 by opening the front cover 46. In other words, as illustrated in FIG. 2, the toner cartridges 41 of the respective colors are arranged to be aligned with the second direction Y and are configured to be detachably attachable to the apparatus main body 72 in the first direction X. An arrow direction of the first direction X is a detachment direction in which the toner cartridge 41 is detached and removed. A direction opposite to the arrow direction of the first direction X is an attachment direction in which the toner cartridge 41 is attached. The toner cartridge 41 is configured to be detachable in this manner.

A toner conveyance mechanism and a toner conveyance path from each of the toner cartridges 41 to the respective developer containers 3 of the corresponding process unit of the process units P are described with reference to FIGS. 3, 4A, 4B, and 5A.

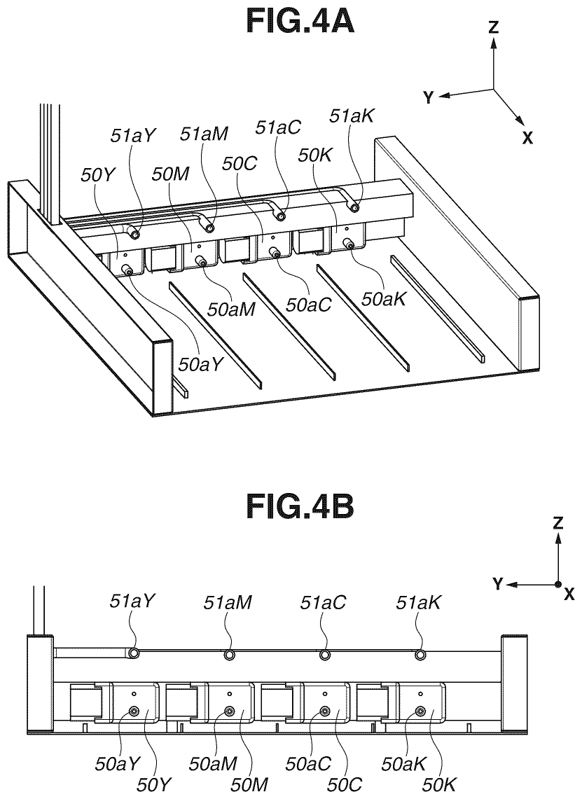

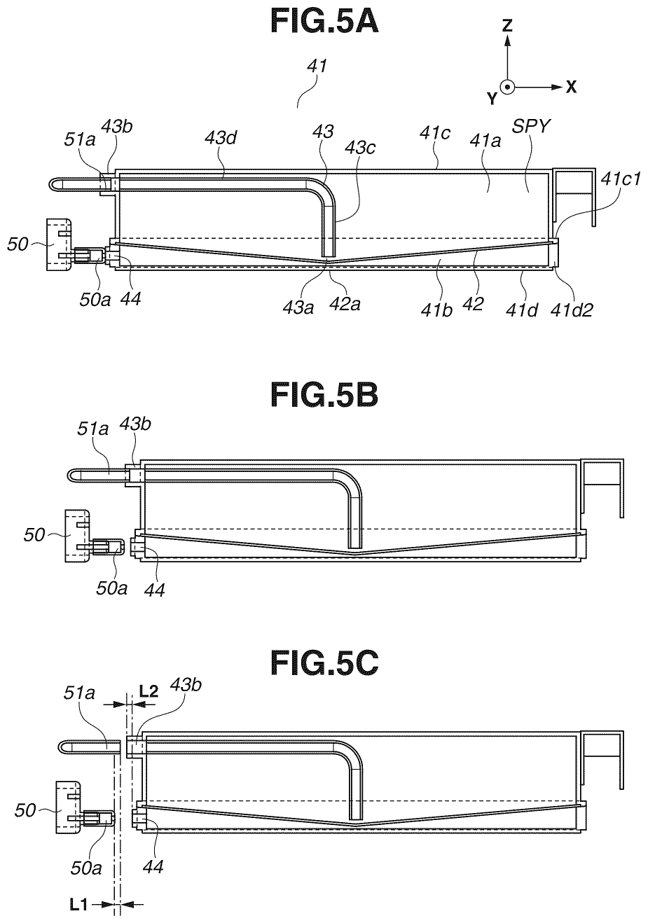

FIG. 3 is a diagram illustrating a perspective view of the toner replenishing unit 40 in a state in which the toner cartridges 41 are attached to the toner replenishing unit 40, and the process units P are attached to the process unit tray 35 (FIG. 2), and the toner conveyance paths 51 each connecting a different toner cartridge of the toner cartridges 41 with a corresponding process unit of the process units P. FIGS. 4A and 4B are diagrams illustrating a perspective view and a front view of a configuration relating to the toner conveyance mechanism of the toner replenishing unit 40 from which the toner cartridges 41 are removed. FIG. 5A is a diagram illustrating a cross-sectional view of the toner cartridge 41.

As illustrated in FIGS. 3, 4A, and 4B, pump units 50Y, 50M, 50C, and 50K (hereinbelow, each may be referred to as pump unit 50) are disposed at the back side of the toner replenishing unit 40. Each of the pump units 50 is aligned with the second direction Y. The pump units 50Y, 50M, 50C, and 50K are referred to as a first pump unit (first pump), a second pump unit (second pump), a third pump unit (third pump), and a fourth pump unit (fourth pump), respectively. As each of the pump units 50, a positive displacement pump, such as a reciprocating pump and a rotary pump, is used. A reciprocating pump performs suction and discharge by reciprocating motion of a piston or a plunger, and examples of the reciprocating pump include a piston pump, a plunger pump, a diaphragm pump, and the like. A rotary pump performs suction and discharge by rotating motion of gears or a rotor, and examples of the rotary pump include a gear pump, a screw pump, a vane pump, and the like. In the present embodiment, a diaphragm pump is adopted. The four pump units (pumps) may be configured as one pump unit. In the present embodiment, the pump units 50 are disposed in the apparatus main body 72, but may be provided each in a different toner cartridge of the toner cartridges 41.

At a back side of each main body of the toner cartridges 41 in the first direction X, discharge ports 50aY, 50aM, 50aC, and 50aK (hereinbelow, each may be referred to as discharge port 50a) via which air generated (sent out) by the pump units 50 is discharged, are disposed in an exposed manner as illustrated in FIG. 5A. Each of the discharge ports 50a opens in the first direction X.

The air discharged from each of the discharge ports 50a in the first direction X is supplied inside the corresponding toner cartridge of the toner cartridges 41 from the air supply port 44 illustrated in FIG. 5A. The air supplied inside each of the toner cartridges 41 is discharged outside from each of the toner cartridges 41 together with the toner T. An internal structure of each of the toner cartridges 41 is described below.

The toner T discharged together with the air from the discharge port of the respective toner cartridges 41 is received by receiving ports 51aY, 51aM, 51aC, and 51aK of the toner replenishing unit 40 illustrated in FIGS. 3 and 5A. Hereinbelow, the receiving ports 51aY, 51aM, 51aC, and 51aK may be each referred to as toner receiving port 51a.

The toner T received via the respective toner receiving ports 51a is received by the toner conveyance paths 51Y, 51M, 51C, and 51K. Hereinbelow, the toner conveyance paths 51Y, 51M, 51C, and 51K may be each referred to as toner conveyance path 51. They also may be referred to as first, second, third, and fourth paths, respectively. Each of the toner conveyance paths 51 is formed of a bendable flexible tube.

In the way described above, each of the discharge ports of the toner cartridges 41 communicates with the corresponding toner conveyance path of the toner conveyance paths 51.

The toner conveyance paths 51 extend to and are connected to the developer containers 3Y, 3M, 3C, and 3K, respectively (FIG. 3). A direction in which the toner T is conveyed in each of the toner conveyance paths 51 is referred to as a toner conveyance direction.

Each of the toner receiving ports 51a opens in the first direction X, with which each of the developing units 9 is aligned. The direction in which each of the toner receiving ports 51a opens is the same as the direction in which each of the discharge ports 50a opens, and a flow direction is an opposite direction.

The toner T received via each of the toner receiving ports 51a is discharged together with the air from the corresponding toner cartridge of the toner cartridges 41. Subsequently, the toner T is conveyed inside the toner conveyance paths 51 from the toner receiving ports 51a to downstream end portions 51bY, 51bM, 51bC, and 51bK (hereinbelow, each may be referred to as downstream end portion 51b), respectively, and each of the process units P is replenished with the toner.

Each of the downstream end portions 51b of the toner conveyance paths 51 is connected to an end portion of the corresponding developing unit of the developing units 9 in the second direction Y. Specifically, the downstream end portion 51bY of the toner conveyance path 51Y is connected to an end portion of the developer container 3Y on an LE side. The developer container 3Y is a part of the process unit PY.

As illustrated in FIG. 3, the LE side refers to a downstream side in a direction of an arrow Y, and an RE side refers to an upstream side in the direction of the arrow Y.

The same is true for the downstream end portion 51bM of the toner conveyance path 51M, the downstream end portion 51bC of the toner conveyance path 51C, and the downstream end portion 51bK of the toner conveyance path 51K. The downstream end portions 51bM, 51bC, and 51bK are connected to end portions of the developer containers 3M, 3C, and 3K, respectively, on the LE side. By reducing a difference in length between the toner conveyance paths 51, a difference in pressure loss caused by the difference in lengths can be reduced. By reducing the difference in pressure loss, a difference in conveyance amount of each toner is reduced, and consequently, the pump unit 50 can be simply configured without introducing color-specific control settings.

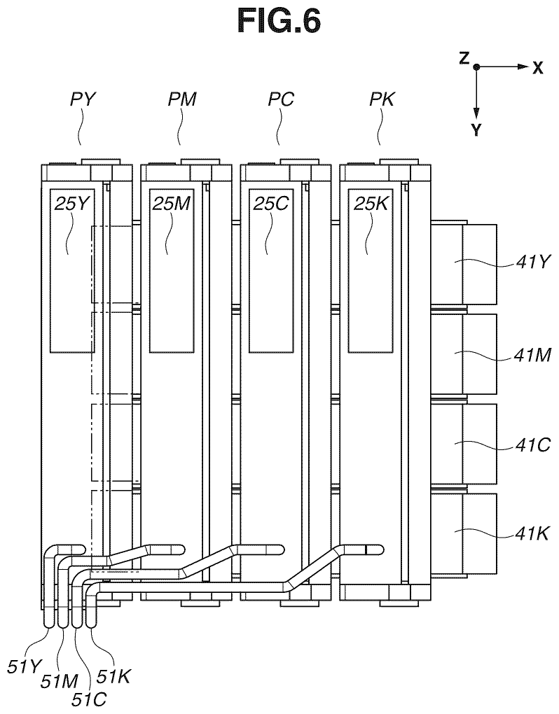

An arrangement of the toner cartridges 41 is described with reference to FIGS. 3 and 6. FIG. 6 is a diagram illustrating the toner cartridges 41 and the process units P as viewed from the third direction Z.

As illustrated in FIG. 3, the toner cartridges 41 and the respective process units P (respective developing units 9) are arranged in such a manner that their longitudinal directions are perpendicular to each other. In other words, when viewed in the third direction Z, at least a part of a plurality of the toner cartridges 41 is arranged to overlap with the respective developing units 9. It can also be said that, when viewed in the third direction Z, at least a part of the developing units 9 is arranged to overlap with the respective toner cartridges 41.

Each of the toner cartridges 41 is arranged in this manner, so that the toner cartridges 41 of four color can be inserted and removed in the first direction X, which is a direction in which the recording medium S is discharged.

The longitudinal direction of the process units P aligns with the second direction Y. As illustrated in FIG. 1, directions of rotation axes of the photosensitive drums 4 and the developing rollers 6 also align with the second direction Y. Thus, the conveyance direction of the recording medium S is in the first direction X when viewed from the third direction Z. The four rotation axes of the respective developing rollers 6 may also be referred to as first, second, third, and fourth rotation axes, respectively.

Here, the longitudinal direction of the toner cartridges 41 is arranged with the first direction X, and as illustrated in FIGS. 4A and 4B, the discharge ports 50a and the toner receiving ports 51a are also arranged to open along the first direction X.

Thus, an insertion and removal direction of the toner cartridge 41 also aligns with the first direction X. It is desirable that a guide structure for supporting insertion and removal of the toner cartridge 41 be provided in the toner replenishing unit 40.

In the way above described, in a case where the recording medium S is taken out from the discharge tray 23, a user can access the discharge tray 23 from the front side of the apparatus main body in the first direction X. Even in a case where the toner cartridges 41 are replaced, the user can directly access the toner cartridges 41 of respective color. In this way, the user can access the recording medium S and the toner cartridges 41 from the same direction, and good usability can be provided.

The user can also access the sheet feeding tray 19 illustrated in FIG. 1 from the front side of the apparatus main body in the first direction X. In other words, the above-described configuration enables the user to access from the same direction in sheet replenishment, sheet removing, and insertion and removal of the toner cartridges 41, which provides good usability.

An arrangement of each of the toner conveyance paths 51 is described.

The toner conveyance paths 51 of the toner T received from the toner receiving ports 51a corresponding to the respective toner cartridges 41 in FIGS. 4A and 4B are collectively provided to one end portion in the second direction Y and then connected to the process units P above as illustrated in FIGS. 3 and 6.

The one end portion in the second direction Y is referred to as a first end portion in the apparatus main body 72. The other end portion on the opposite side is referred to as a second end portion in the apparatus main body 72. A side with the first end portion of the apparatus main body 72 is referred to as a first end portion side, and a side with the second end portion of the apparatus main body 72 is referred to as a second end portion side.

The toner conveyance paths 51 connecting the toner replenishing unit 40 and the apparatus main body 72 are set into one bundle, so that the number of components (not illustrated) for holding these paths inside the apparatus main body 72 can be reduced. In other words, the configuration of the apparatus main body 72 can be simplified.

A connection section may be provided in the toner conveyance paths 51 so that the toner conveyance paths 51 can be separated between the toner replenishing unit 40 and the apparatus main body 72. With this configuration, the toner replenishing unit 40 is detachably attachable in a state in which the toner conveyance paths 51 are separated at the connection section.

### (Connection Between Process Cartridge and Toner Conveyance Path)

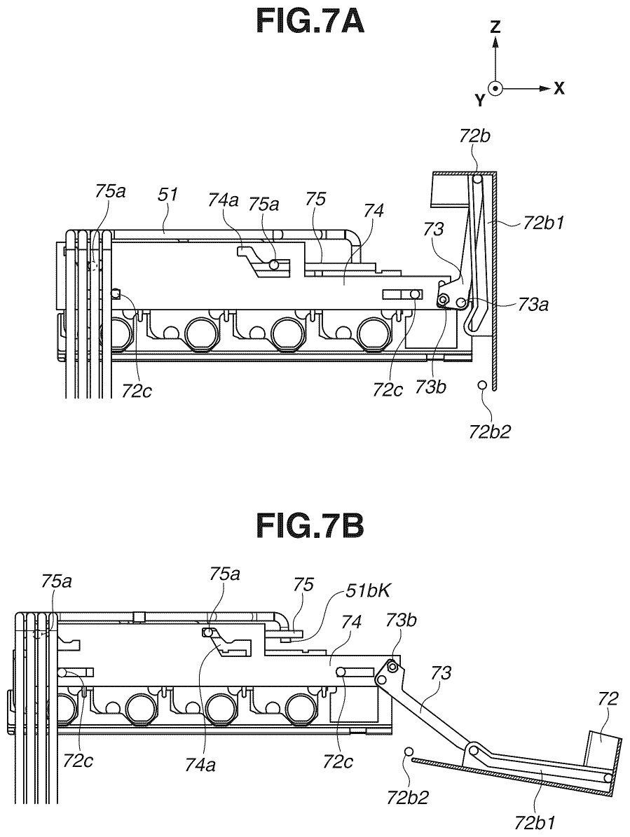

FIGS. 7A and 7B are diagrams illustrating an operation of the connection section between the process unit P and the toner conveyance path 51. FIGS. 7A and 7B illustrate the front door 72b in a closed state and an open state, respectively.

Each of the toner conveyance paths 51 is supported by a vertical movement member 75. The vertical movement member 75 is pressed downward by a slide member 74. The toner conveyance paths 51 connect the downstream end portions 51b to the process units P via the respective vertical movement member 75.

An opening to which each of the downstream end portion 51b is connected corresponds to a receiving port of a different developer container of the developer containers 3 of the respective process unit P. The receiving ports of yellow, magenta, cyan, and black are referred to as first, second, third, and fourth receiving ports, respectively.

An operation performed in releasing the connection of the downstream end portions 51b of the toner conveyance paths 51 is described with reference to FIG. 7B. The front door 72b is opened by pivoting around a rotation shaft 72b2. A link member 73 pivots around a rotation shaft 73a while engaging with a long hole 72b1 of the front door 72b.

The slide member 74 is held slidably in the first direction X by a shaft 72c, which is disposed in the apparatus main body 72, engaging with a long hole of the slide member 74.

The slide member 74 is pulled by a shaft 73b of the link member 73 in the first direction X and thus moves in the first direction X. An inclined surface formed in a hole 74a of the slide member 74 is also moved in the first direction X. A shaft 75a of the vertical movement member 75 relatively moves along the inclined surface in the third direction Z. With this operation, the vertical movement member 75 is separated from the process unit P, and the connection between the downstream end portion 51b of the toner conveyance path 51 and the process unit P is released, so that the process unit tray 35 can be pulled out in the first direction X as illustrated in FIG. 2.

### (Structure of Cartridge)

A structure of each of the toner cartridges 41 according to the present embodiment is described with reference to FIG. 5A. The toner cartridge 41 includes a first frame 41c, a second frame 41d, and the filter 42. The toner discharge ports 43b (first, second, third, and fourth discharge ports) are disposed in the first frame 41c.

The first frame 41c and the second frame 41d are injection molded members made of resin. The toner discharge port 43b may be provided with a sealing member (a seal or a shutter), which is not illustrated. The sealing member is configured to seal the toner discharge port 43b to prevent the toner T stored inside the toner cartridge 41 from leaking outside the toner cartridge 41 in a state in which the toner cartridge 41 is not attached to the toner replenishing unit 40. In a case where the toner cartridge 41 is attached to the toner replenishing unit 40, the sealing member is removed or moved to open the toner discharge port 43b.

The first frame 41c and the second frame 41d include a flange portion 41c1 and a flange portion 41d2, respectively. The flange portion 41c1 and the flange portion 41d2 welded to each other by ultrasonic welding, thereby an internal space SPY of the toner cartridge 41 illustrated in FIG. 5A is formed. The flange portion 41c1 and the flange portion 41d2 may be fixed to each other with an adhesive or a screw. In this way, the first frame 41c is assembled to the second frame 41d.

The filter 42 is disposed to partition the internal space SPY of the toner cartridge 41 into two chambers, the toner chamber 41a and the air chamber 41b. In other words, the air chamber 41b is adjacent to the toner chamber 41a with the filter 42 therebetween.

The toner chamber 41a is configured to store the toner T. In the toner chamber 41a, the toner T is supported by the filter 42 in the third direction Z. The toner is not stored in the air chamber 41b. The filter 42 is configured with a porous member made of, for example, a resin fiber and has pores of a size and density that allow air to pass through but prevent toner from passing through. In other words, the filter 42 is configured to allow air to pass through and prevent toner from passing through.

As described above, the filter 42 is held by the first frame 41c and the second frame 41d by being held between the flange portion 41c1 of the first frame 41c and the flange portion 41d2 of the second frame 41d. The filter 42 has an inclination portion that is inclined downward toward a lowermost portion 42a in the first direction X.

The toner chamber 41a is provided with the toner path 43. The toner path 43 according to the present embodiment is an injection molded tubular member made of resin. The toner path 43 may be formed of paper, rubber, or the like. The toner path 43 includes the toner suction port 43a and the toner discharge port 43b. The toner path 43 is a path through which the toner T stored in the toner chamber 41a passes when the toner T is conveyed toward the toner discharge port 43b. The toner path 43 includes a first portion 43c that is provided with the toner suction port 43a as an inlet and extends in the third direction Z, and a second portion 43d that is provided with the toner discharge port 43b as an outlet and extends in the first direction X.

The direction in which the first portion 43c extends and the direction in which the second portion 43d extends are configured to intersect with each other. The toner suction port 43a and the lowermost portion 42a, which is a part of the filter 42, are arranged to face each other with a gap therebetween. It is desirable that the toner suction port 43a be arranged adjacent to the lowermost portion 42a.

In a case where a remaining amount of the toner T in the toner chamber 41a is reduced, the toner T that is fluidized by air received from the air supply port 44 moves along the inclination of the filter 42 described above and is collected at the lowermost portion 42a. The toner suction port 43a of the toner path 43 guides the toner T collected at the lowermost portion 42a of the filter 42 to the toner discharge port 43b. In this way, the inclination of the filter 42 collects the toner T at the lowermost portion 42a of the filter 42, and the collected toner T passes through the toner suction port 43a provided in proximity to the lowermost portion 42a and is conveyed to the toner discharge port 43b.

In the way described above, even in a case where the remaining amount of the toner T stored in the toner chamber 41a of the toner cartridge 41 is reduced, the toner T at the lowermost portion 42a can be efficiently discharged outside the toner cartridge 41.

The cartridge according to the present embodiment has a structure in which the toner is discharged outside the cartridge by air, allowing omission of a rotating member, such as a screw. Accordingly, the cartridge can have a simple structure with a small number of components.

### (Toner Conveyance Mechanism)

A mechanism for conveying the toner T stored in the toner chamber 41a of the toner cartridge 41 to the developing unit 9 is described with reference to FIG. 5A.

Air discharged from the discharge port 50a of the pump unit 50 is received in the air chamber 41b via the air supply port 44 of the toner cartridge 41. Then, the air increases an air pressure in the air chamber 41b, passes through the filter 42, and flows into the toner chamber 41a. The air that flows into the toner chamber 41a enters between particles of the toner T and fluidizes the toner T. The toner T that is mixed with the air and fluidized is conveyed by the air received in the air chamber 41b through the air supply port 44. The toner T is conveyed via the toner path 43 from the toner suction port 43a to the toner discharge port 43b and is discharged outside the toner cartridge 41 from the toner discharge port 43b.

The air chamber 41b, which is a highly airtight space, is provided between the air supply port 44 and the filter 42 as according to the present embodiment, so that the air discharged from the discharge port 50a is efficiently directed to the filter 42 without dispersing outside the toner cartridge 41. For example, there can be a case where the toner cartridge 41 is in a state in which the toner T in the toner chamber 41a is likely to aggregate due to the fact that the toner cartridge 41 is vibrated or left for a long time, for example. In such a case, a pressure to cause air to pass through the filter 42 and flow into the toner cartridge 41 is increased. Even in such a case, the pump unit 50 continues to properly send air to the air chamber 41b to increase the pressure (air pressure) in the air chamber 41b, so that air is able to be sent to the toner chamber 41a through the filter 42. In the configuration including the air chamber 41b, it is sufficient for the pump unit 50 to have a capacity to generate pressure capable of continuing to send air into the air chamber 41b until the air chamber 41b reaches the pressure causing the air to pass through the filter 42 into the toner chamber 41a. Since no specific requirements are imposed on the discharge speed or the discharge amount, even a small pump unit can be adopted. This can contribute to downsizing of the image forming apparatus 1.

As illustrated in FIG. 5A, the toner T discharged from the toner discharge port 43b of the toner cartridge 41 is conveyed to the downstream end portion 51b via the toner receiving port 51a of the toner conveyance path 51, and the developer container 3 of the process unit P is replenished with the toner T.

As illustrated in FIG. 3, the toner T as well as air flows into the developer container 3 of the process unit P from the toner conveyance path 51, so that an internal pressure of the developer container 3 tends to increase. Thus, a filter is provided on an upper surface of the developer container 3 of the process unit P. The filter is an exhaust filter portion 25. The exhaust filter portion 25 is a portion in which a through hole is provided in a frame portion that configures the developer container 3 of the process unit P, and a filter, such as a non-woven fabric, is provided in the through hole. The toner T flows from the toner conveyance path 51 to the inside of the developer container 3 of the process unit P together with air. The air is exhausted outside the process unit P through the exhaust filter portion 25 that allows the air to pass through but blocks the toner T from passing through. Accordingly, an increase in the internal pressure of the developer container 3 of the process unit P is suppressed. If the internal pressure increases, the toner T and air tend to hardly flow from the toner cartridge 41 into the developer container 3 through the toner conveyance path 51, but with the configuration described above, such a phenomenon is less likely to occur.

### (Attachment and Detachment of Toner Cartridge)

An operation of connecting the toner discharge port 43b and the air supply port 44 in attaching and detaching the toner cartridge 41 is described with reference to FIGS. 5A to 5C.

FIG. 5A is a diagram illustrating a state in which the toner cartridge 41 is attached to the toner replenishing unit 40. FIG. 5B is a diagram illustrating a state in which the toner cartridge 41 is slightly pulled out relatively from the toner replenishing unit 40. FIG. 5C is a diagram illustrating a state in which the toner cartridge 41 is pulled out further from the toner replenishing unit 40 than in the state in FIG. 5B.

When the toner cartridge 41 is pulled out in the first direction X, as illustrated in FIG. 5B, the air supply port 44 is separated away from the discharge port 50a. Subsequently, when the toner cartridge 41 is further pulled out, as illustrated in FIG. 5C, the toner discharge port 43b is separated away from the toner receiving port 51a.

The toner receiving port 51a is provided in such a manner that the toner receiving port 51a protrudes in the first direction X by a distance L1 in FIG. 5C beyond the discharge port 50a of the pump unit 50. The toner discharge port 43b of the toner cartridge 41 is provided in such a manner that the toner discharge port 43b protrudes in the first direction X by a distance L2 in an insertion direction beyond the air supply port 44.

With the above-described configuration, an air supply path by the pump unit 50 is first released by the removal of the toner cartridge 41, and then a toner discharge path is released. Even in a case where the internal pressure of the toner cartridge 41 is high immediately after a toner conveyance operation, toner leakage is less likely to occur. This is because the air supply path is first released, and then the toner discharge path is released after the internal pressure of the toner cartridge 41 is sufficiently reduced.

### Second Embodiment

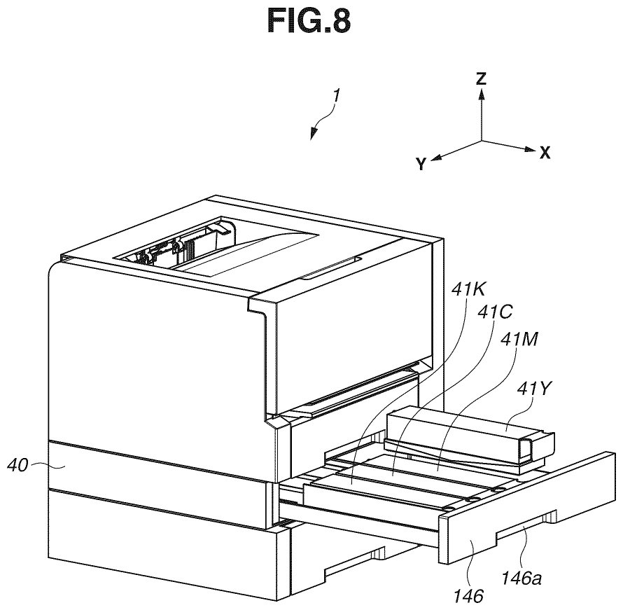

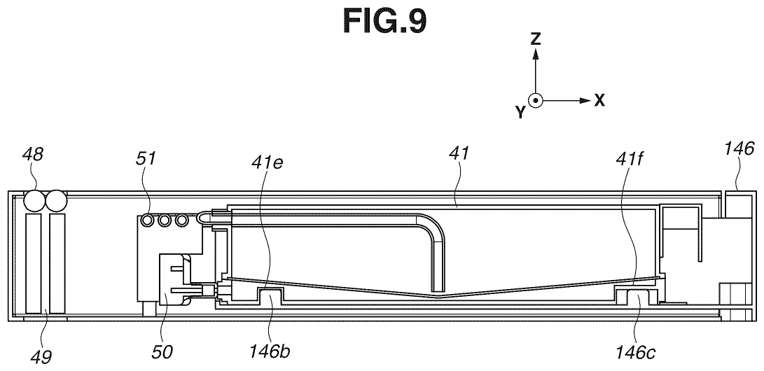

An image forming apparatus 1 according to a second embodiment of the present disclosure is described with reference to FIGS. 8 and 9.

FIG. 8 is a diagram illustrating a perspective view of a state in which a toner cartridge tray 146 of the image forming apparatus 1 is pulled out. The redundant description of a configuration of an image forming unit similar to that according to the first embodiment is omitted.

A configuration different from that according to the first embodiment is described with reference to FIG. 9, which is a diagram illustrating a cross-sectional view of the toner replenishing unit 40.

A toner replenishing unit 40 can mount toner cartridges 41 thereon and includes a toner cartridge tray 146 that holds the toner cartridges 41 at the time of being mounted. As illustrated in FIG. 8, the toner cartridge tray 146 includes a handle portion 146a to pull the toner cartridge tray 146 out in a first direction X. The toner cartridge tray 146 is configured to be slidable in the first direction X relative to the toner replenishing unit 40. The toner cartridge tray 146 includes a first positioning portion 146b and a second positioning portion 146c for positioning the toner cartridge 41. A first engaged portion 41e and a second engaged portion 41f of the toner cartridge 41 are engaged with the first positioning portion 146b and the second positioning portion 146c, respectively.

When the toner cartridge tray 146 is pulled out from the toner replenishing unit 40 in the first direction X from an internal position to an external position, because the toner cartridges 41 are positioned with respect to the toner cartridge tray 146, the toner cartridges 41 are pulled out together with.

After pulling out the toner cartridge tray 146, a user can take the toner cartridges 41 out from the toner cartridge tray 146 in the third direction Z to replace the toner cartridges 41.

The toner cartridges 41 can be replaced in a state in which the toner cartridges 41 are placed on the toner cartridge tray 146 pulled out to the external position of the toner replenishing unit 40. The user can pull out the toner cartridges 41 to a position near his/her hand, allowing for easy replacement. Further, the toner cartridge 41 can be maintained at a height that is easy for the user to work on during replacement. Thus, workability in replacing the toner cartridge 41 is excellent.

A direction in which the toner cartridge tray 146 is pulled out aligns with the first direction X, which is the same as the direction in which the sheet feeding tray of the recording medium S and an optional sheet feeding tray are pulled out. Since the user can perform these operations including operations of replacing the toner cartridge 41, replenishing the recording medium S, and removing the recording medium S from the discharge tray from the front side of the image forming apparatus 1, the image forming apparatus 1 is excellent in operability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-158772, filed Sep. 13, 2024, which is hereby incorporated by reference herein in its entirety.

What is claimed is:

1. An image forming apparatus comprising:
a first toner container configured to store first toner;
a second toner container configured to store second toner, the second toner container being aligned with the first toner container in a first direction intersecting a direction of gravity; and
an apparatus main body configured in such a manner that the first toner container and the second toner container are detachably attachable to the apparatus main body,
wherein the apparatus main body includes
a first developing unit that includes a first developing roller configured to be rotatable to carry the first toner and a first developer container for storing the first toner to be carried by the first developing roller, and is disposed above the first toner container and the second toner container,
a second developing unit that includes a second developing roller configured to be rotatable to carry the second toner and a second developer container for storing the second toner to be carried by the second developing roller, is aligned with the first developing unit in a second direction intersecting both the first direction and the direction of gravity, and is disposed above the second toner container, and
a first path through which the first toner passes, and
wherein the first developer container is replenished with the first toner from the first toner container through the first path, when viewed in the direction of gravity, both the direction in which the first toner container is detachably mounted, and the direction in which the sheet is discharged onto the discharge tray, are the second direction.

2. The image forming apparatus according to claim 1, wherein the first developing unit overlaps at least a part of the first toner container and at least a part of the second toner container when viewed in the direction of gravity.

3. The image forming apparatus according to claim 1, wherein the first toner container overlaps at least a part of the first developing unit and at least a part of the second developing unit when viewed in the direction of gravity.

4. The image forming apparatus according to claim 1, wherein a longitudinal direction of the first toner container and a longitudinal direction of the second toner container are the second direction.

5. The image forming apparatus according to claim 1 further comprising a second toner path through which the second toner passes,
wherein and the second developer container is replenished with the second toner from the second toner container through the second path;
wherein the apparatus main body includes a pump that discharges air;
wherein the first toner is replenished from the first toner container to the first developer container through the first path by the air discharged by the pump, and
wherein the second toner is replenished from the second toner container to the second developer container through the second path by the air discharged by the pump.

6. The image forming apparatus according to claim 1, wherein the first toner container and the second toner container are attached to the apparatus main body by being moved in an attachment direction along the second direction with respect to the apparatus main body and is detached from the apparatus main body by being moved in a detachment direction that is a direction opposite to the attachment direction with respect to the apparatus main body.

7. The image forming apparatus according to claim 6 further comprising a second toner path through which the second toner passes,
wherein and the second developer container is replenished with the second toner from the second toner container through the second path;
wherein a first discharge port for discharging the first toner and communicating with an end portion of the first path on an upstream side in a toner conveyance direction is provide at an end portion of the first toner container on a downstream side in the attachment direction, and
wherein a second discharge port for discharging the second toner and communicating with an end portion of the second path on the upstream side in the toner conveyance direction is provided at an end portion of the second toner container on the downstream side in the attachment direction.

8. The image forming apparatus according to claim 7, wherein, when one end portion and another end portion of the apparatus main body in the first direction are defined as a first end portion and a second end portion, respectively,
a first receiving port communicating with an end portion of the first path on a downstream side in the toner conveyance direction is provided at an end portion of the first developer container on a side with the first end portion in the first direction, and
a second receiving port communicating with an end portion of the second path on the downstream side in the toner conveyance direction is provide at an end portion of the second developer container on the side with the first end portion in the first direction.

9. The image forming apparatus according to claim 8,
wherein the first path includes a first part extending upward,
wherein the second path includes a second part extending upward; and
the first part and the second part are disposed on the side with the first end portion of the apparatus main body in the first direction and on the downstream side in the attachment direction.

10. The image forming apparatus according to claim 1 further comprising a second toner path through which the second toner passes,
wherein and the second developer container is replenished with the second toner from the second toner container through the second path;
wherein the first path and the second path are each configured with a bendable flexible tube.

11. The image forming apparatus according to claim 1, further comprising a toner container support portion that detachably supports the first toner container and the second toner container,
wherein the toner container support portion is configured to be connected to the apparatus main body in the direction of gravity,
the first path includes a first path portion provided inside the toner container support portion and a second path portion provided inside the apparatus main body,
and in the state where the toner container support portion is attached to the apparatus main body, an end of the first path portion and an end of the second path portion are connected to form a connection section.

12. The image forming apparatus according to claim 1, further comprising a movement member that mounts the first developing unit and the second developing unit thereon and moves with respect to the apparatus main body along the second direction between an internal position where the first developing unit and the second developing unit are located inside the apparatus main body, and an external position where at least a part of the first developing unit and at least a part of the second developing unit are exposed outside the apparatus main body.

13. The image forming apparatus according to claim 1, further comprising a movement member that mounts the first toner container and the second toner container thereon and moves with respect to the apparatus main body along the second direction between an internal position where the first toner container and the second toner container are located inside the apparatus main body, and an external position where at least a part of the first toner container and at least a part of the second toner container are exposed outside the apparatus main body.

14. The image forming apparatus according to claim 5,
wherein the first toner container includes
a first frame configured to include a receiving port that receives air from the pump,
a second frame assembled to the first frame and configured to have a space therein together with the first frame,
a filter fixed with its outer periphery and configured to partition the space into an air chamber including the receiving port and a toner storage chamber for storing toner, the filter restricting passage of toner and allowing passage of air between the air chamber and the toner storage chamber, and
a discharge port configured to discharge toner together with air from the toner storage chamber to the outside.
